(19) United States
(12) Patent Application Publication
(10) Pub. No.: US 2018/0154586 A1
(43) Pub. Date: Jun. 7, 2018

(54) FEEDING DEVICE AND VARIABLE SQUEEZING MOUTH FOR 3D PRINTING

(71) Applicant: INDUSTRIAL TECHNOLOGY RESEARCH INSTITUTE, Hsinchu (TW)

(72) Inventors: Teng-Yen WANG, Yunlin County (TW); Lung-Wu CHANG, Tainan City (TW); Yen-Bor FANG, Pingtung County (TW); Yang-Cheng LIN, Chiayi City (TW)

(73) Assignee: INDUSTRIAL TECHNOLOGY RESEARCH INSTITUTE, Hsinchu (TW)

(21) Appl. No.: 15/389,141

(22) Filed: Dec. 22, 2016

(30) Foreign Application Priority Data
Dec. 2, 2016 (TW) 105140010

(51) Int. Cl. B29C 67/00; B33Y 30/00

(52) U.S. Cl. CPC B29C 67/0085; B33Y 30/00; B29C 67/0055

(57) ABSTRACT

A feeding device and a variable squeezing mouth are provided. The feeding device includes a first roller, a second roller and a middle guiding structure. The second roller and the first roller have a first zone therebetween. At least a part of the middle guiding structure is positioned in the first zone. The middle guiding structure has a passage being aligned with and connected to the first zone. The variable squeezing mouth includes a main body, a collet and a nut. The collet includes a base and at least two arms. The arms form a filament outlet. While the nut or the collet is moved with respect to the main body, the at least two arms and the nut are pressed against each other, so that a distance between the at least two arms is changed, and the size of the filament outlet is changed.

### CROSS-REFERENCE TO RELATED APPLICATIONS

This non-provisional application claims priority under 35 U.S.C. § 119(a) on Patent Application No(s). 105140010 filed in Taiwan, R.O.C. on Dec. 2, 2016, the entire contents of which are hereby incorporated by reference.

### TECHNICAL FIELD

The disclosure relates to a feeding device and a variable squeezing mouth for 3D printing, more particularly to a feeding device having guiding structure, and a variable squeezing mouth having arms.

### BACKGROUND

3D printing is one of the rapid prototyping technologies. In operation, a digital 3D model is constructed in a layer-by-layer manner, and then a powder-like, liquid-like, or a thread-like plastic or metal material is melted while being inserted into a 3D printhead, and then the melted material is deposited on a platform, layer by layer, to form a 3D object according to the data of the digital 3D model. This technology is also known as Fused Deposition Modeling (FDM). In most cases, a relatively hard thermoplastic material, such as Polylactic Acid (PLA) and Acrylonitrile Butadiene Styrene (ABS), having a Shore hardness of about 80 is widely used in 3D printing.

In recent years, the requirement of shoe pads, tires, soft cups and non-toxic toys which are made of rubber like, high-elastic, soft and colorable material is increased, so some developers start to use a relatively soft material, such as polyurethane (PU), thermoplastic Polyurethane (TPU), ethylene vinyl acetate copolymer (EVA), having a Shore hardness of about less than 45 for 3D printing.

### SUMMARY

The present disclosure provides a feeding device in order to solve the problem that the filament is easy to become tangled to block the filament inlet, and the filament inlet is easy to be blocked by the filament dust in the traditional 3D printheads. Also, the present disclosure provides a variable squeezing mouth which is able to adjust the radial size of the melted filament.

One embodiment of the disclosure provides a feeding device for a 3D printhead. The feeding device is for feeding a filament. The feeding device includes a first roller, a second roller and a middle guiding structure. The second roller is positioned close to the first roller and movable by the first roller. The second roller and the first roller have a first zone therebetween. The second roller and the first roller are for pressing and feeding the filament. At least a part of the middle guiding structure is positioned in the first zone. The middle guiding structure has a passage being aligned with and connected to the first zone.

One embodiment of the disclosure provides a variable squeezing mouth, having an extruding passage. The variable squeezing mouth is for extruding a filament. The variable squeezing mouth includes a main body, a collet and a nut. The collet includes a base and at least two arms. The base is movably disposed on the main body. The at least two arms are separated from one another and positioned on a side of the base. The extruding passage penetrates the main body and the collet. The at least two arms form a filament outlet of the extruding passage. The nut is movably engaged in the main body, and wraps around the at least two arms. While the nut or the collet is moved with respect to the main body, the at least two arms and the nut are pressed against each other, so that a distance between the at least two arms is changed, and the size of the filament outlet is changed.

### BRIEF DESCRIPTION OF THE DRAWINGS

The present invention will become better understood from the detailed description given hereinbelow and the accompanying drawings which are given by way of illustration only and thus are not limitative of the present invention and wherein:

FIG. 1 is a perspective view of a 3D printhead according to one embodiment of the disclosure;

FIG. 2 is a front view of the 3D printhead in FIG. 1;

FIG. 3 is a top view of the 3D printhead in FIG. 1;

FIG. 4 is a side view of the 3D printhead in FIG. 1;

FIG. 5 is a partial enlarged view of a feeding device in FIG. 2;

FIG. 6 is a side cross-sectional view of a variable squeezing mouth in FIG. 1;

FIG. 7 is a partial enlarged view of the variable squeezing mouth in FIG. 6; and

FIG. 8 shows the operation of the variable squeezing mouth in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

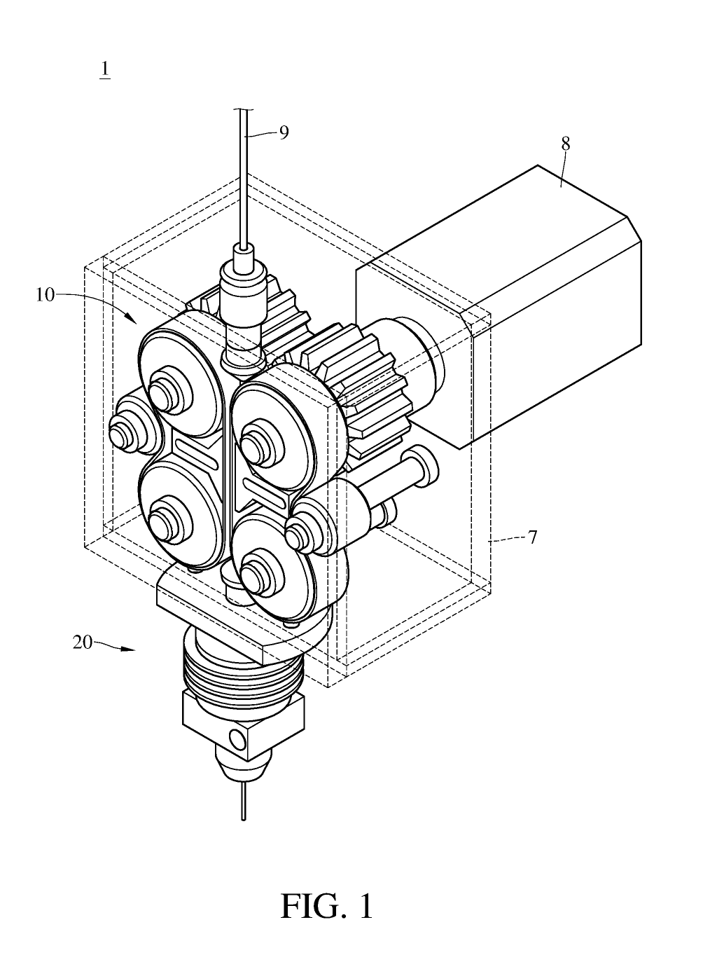

Please refer to FIG. 1, which is a perspective view of a 3D printhead according to one embodiment of the disclosure. In this embodiment, a 3D printhead 1 is provided. The 3D printhead 1 includes a feeding device 10 and a variable squeezing mouth 20 for 3D printing. The variable squeezing mouth 20 is disposed on a side of the feeding device 10, and the feeding device 10 is disposed in a case 7, but the present disclosure is not limited to the case 7. For the purpose of illustration, the case 7 in FIG. 1 is shown in dotted line. A filament 9 is able to be fed into the variable squeezing mouth 20 by the feeding device 10. The filament 9 is heated and melted to a molten state by the variable squeezing mouth 20, and then the melted filament 9 is gradually deposited on a platform to form a 3D object. This process including the aforementioned steps for depositing the filament 9 is called Fused Deposition Modeling (FDM). In addition, the said filament 9 is made of, for example, ABS resin, Polylactic acid, PU, TPU, EVA resin, Nylon or wax that becomes soft, melted and flowable when heated to a specific temperature and hard when cooled, but the present disclosure is not limited thereto.

Then, the feeding device 10 and the variable squeezing mouth 20 are described in the following paragraphs.

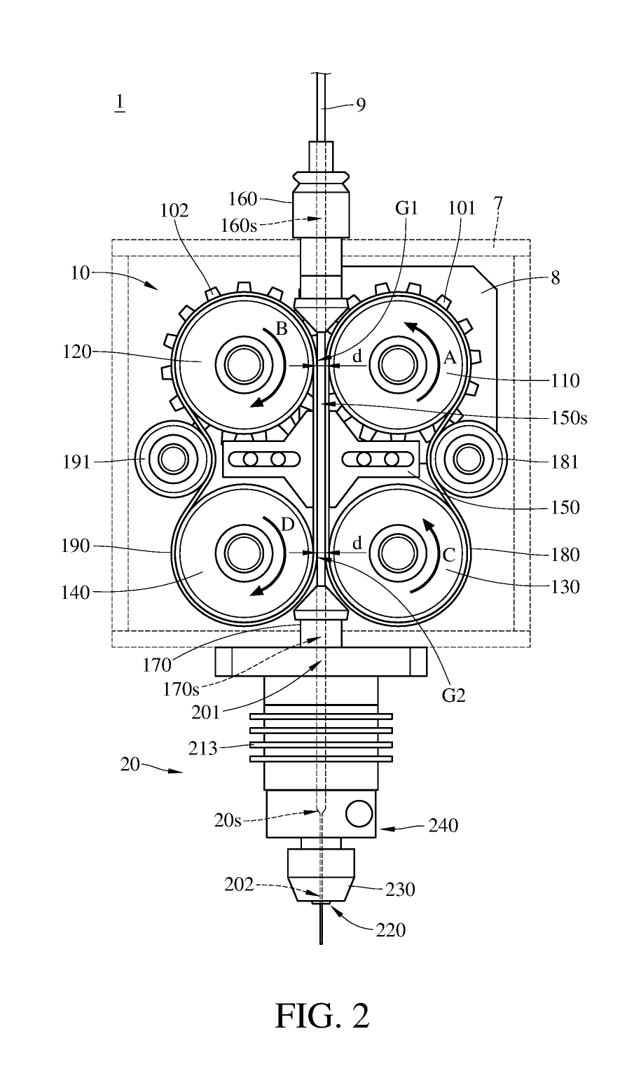

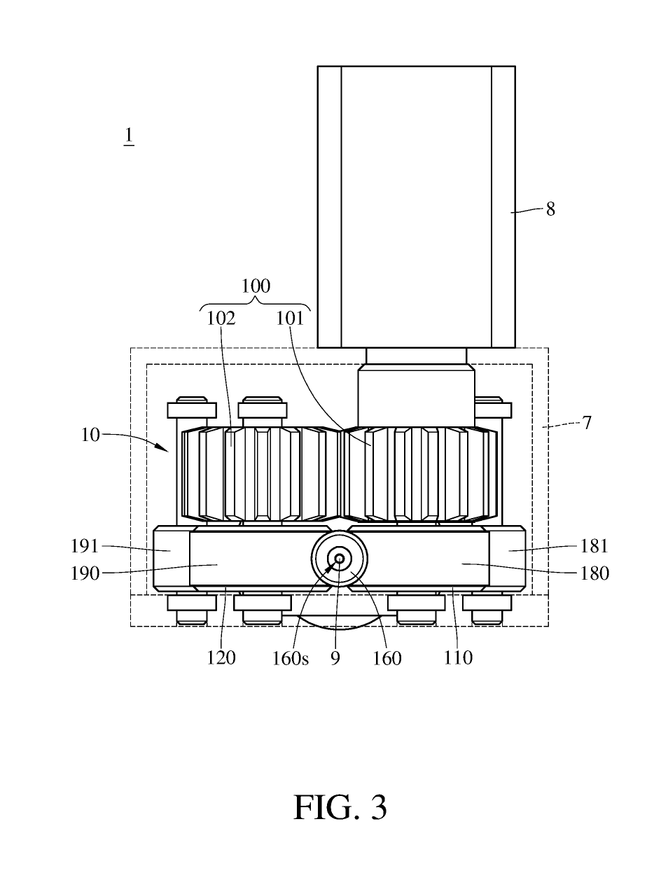

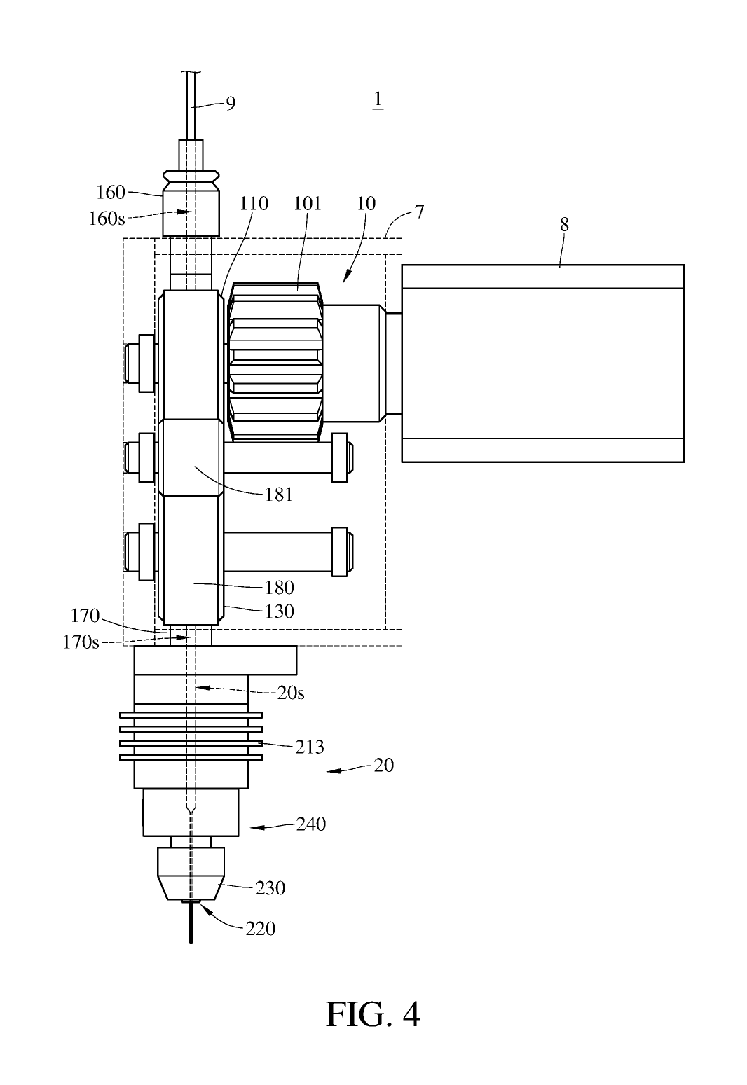

Firstly, please refer to FIG. 1 and further refer to FIGS. 2 to 4, FIG. 2 is a front view of the 3D printhead in FIG. 1, FIG. 3 is a top view of the 3D printhead in FIG. 1, and FIG. 4 is a side view of the 3D printhead in FIG. 1. For the purpose of illustration, the case 7 in FIGS. 2 to 4 is shown in dotted line.

In detail, the feeding device 10 includes a drive roller set 100, a first roller 110, a second roller 120, a third roller 130 and a fourth roller 140, a middle guiding structure 150, a feeding guiding structure 160, an extruding guiding structure 170, a first belt 180, a first tension wheel 181, a second belt 190 and a second tension wheel 191.

The drive roller set 100 includes a first engaged roller 101 and a second engaged roller 102 which are engaged with each other. The first engaged roller 101 is fixed to the first roller 110 in order to drive the first engaged roller 101 to rotate. The first engaged roller 101 is a toothed roller, and the first engaged roller 101 is able to be connected to a power source 8. The power source 8 is able to drive the first engaged roller 101 and the first roller 110 to rotate. The said power source 8 is, for example, a stepper motor, but the present disclosure is not limited thereto.

The second engaged roller 102 is fixed to the second roller 120 in order to drive the second roller 120 to rotate. The second engaged roller 102 is also a toothed roller, and the second engaged roller 102 is engaged with the first engaged roller 101. Therefore, the second engaged roller 102 and the second roller 120 are able to be rotated by the first engaged roller 101. The rotational direction of the first roller 110 is opposite to the rotational direction of the second roller 120. As shown in FIG. 2, when the first roller 110 is rotated in a direction of arrow A, the second roller 120 is rotated in a direction of arrow B by being driven by the first roller 110, and the direction of arrow A is opposite to the direction of arrow B. However, the present disclosure is not limited to the position or the number of the power source 8. In another embodiment, the power source 8 may be connected to the second engaged roller 102. In yet another embodiment, there are two power sources 8, and the two power sources 8 are respectively connected to the first engaged roller 101 and the second engaged roller 102. Furthermore, the drive roller set 100 is optional. In some embodiments, the drive roller set 100 may be omitted. In such a case, the first roller 110 and the second roller 120 may be respectively driven by two power sources 8.

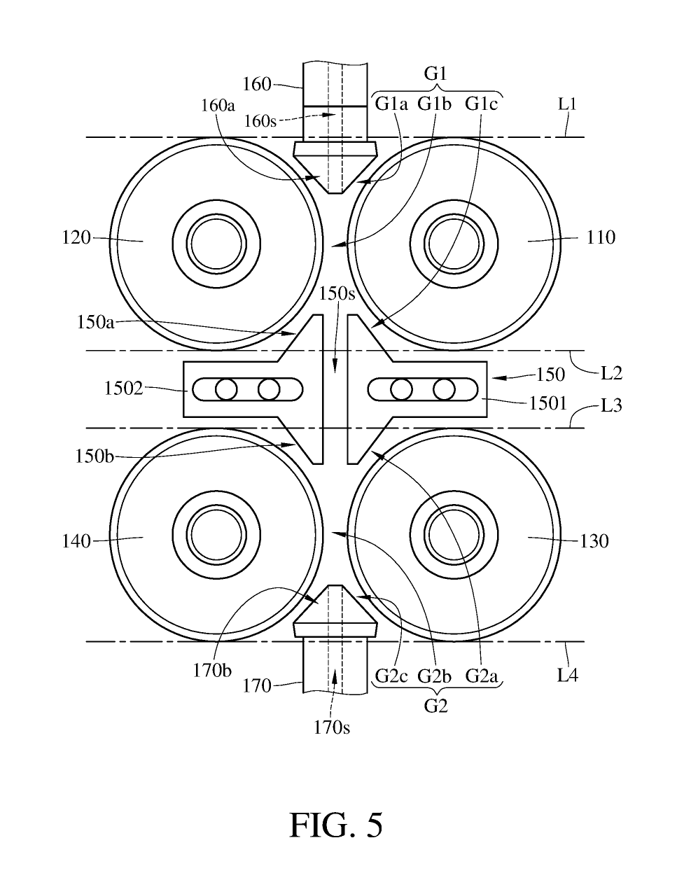

In addition, there is a first zone G1 formed between the first roller 110 and the second roller 120. Please refer to FIG. 5, which is a partial enlarged view of a feeding device in FIG. 2. For the purpose of illustration, the drive roller set 100, the first belt 180 and the second belt 190 are omitted in FIG. 5. In this embodiment, the said first zone G1 is an zone defined by the first roller 110, the second roller 120, and two outer common tangents L1 and L2 of the first roller 110 and the second roller 120. From the point of view of FIG. 5, the first zone G1 is in a hourglass shape consisting of two funnel shapes connected at their tips. The first zone G1 has a first feeding section G1a, a first pressing section G1b and a first extruding section G1c. The first pressing section G1b is connected to and positioned between the first feeding section G1a and the first extruding section G1c.

Furthermore, in this embodiment, the first roller 110 and the second roller 120 are same in shape, and diameter, but the present disclosure is not limited thereto. In some embodiments, the first roller and the second roller may be different in diameter.

The middle guiding structure 150 is positioned below the first roller 110 and the second roller 120. The middle guiding structure 150 has a feeding passage 150s. At lease a part of the middle guiding structure 150 is positioned in the first extruding section G1c of the first zone G1, and an end of the feeding passage 150s is aligned with and connected to the first pressing section G1b of the first zone G1 in order to guide the filament 9 to feed into the first zone G1. In more detail, the middle guiding structure 150 is formed by two guiding structures 1501 and 1502, and the feeding passage 150s is formed by the guiding structures 1501 and 1502. In addition, the guiding structures 1501 and 1502 jointly form a cone shaped end 150a positioned in the first extruding section G1c of the first zone G1, which is favorable for the middle guiding structure 150 to be placed closer to the first roller 110 and the second roller 120; also, the cone shaped end 150a is favorable for the middle guiding structure 150 to be aligned with the first pressing section G1b of the first zone G1, to guide the filament 9 to feed into the first zone G1.

The third roller 130 and the fourth roller 140 are positioned close to a side of the middle guiding structure 150 which is opposite to the first roller 110 and the second roller 120. From the point of view of FIG. 2, the third roller 130 and the fourth roller 140 are positioned below the middle guiding structure 150. There is a second zone G2 formed between the third roller 130 and the fourth roller 140. As shown in FIG. 5, the second zone G2 is similar to the first zone G1, the said second zone G2 is an zone defined by the third roller 130, the fourth roller 140, and two outer common tangents L3 and L4 of the third roller 130 and the fourth roller 140. From the point of view of FIG. 5, the second zone G2 is also in a hourglass shape consisting of two funnel shapes connected at their tips. The second zone G2 has a second feeding section G2a, a second pressing section G2b and a second extruding section G2c. The second pressing section G2b is connected to and positioned between the second feeding section G2a and the second extruding section G2c. At least a part of the middle guiding structure 150 is positioned in the second feeding section G2a of the second zone G2, and another end of the feeding passage 150s is aligned with and connected to the second pressing section G2b of the second zone G2. In more detail, the guiding structures 1501 and 1502 of the middle guiding structure 150 form a cone shaped end 150b which is opposite to the cone shaped end 150a and positioned in the second feeding section G2a of the second zone G2, which is favorable for the middle guiding structure 150 to be place closer to the third roller 130 and the fourth roller 140; also, the cone shaped end 150a is favorable for the middle guiding structure 150 to be aligned with the second pressing section G2b of the second zone G2, to guide the filament 9 to feed into the second zone G2.

Furthermore, in this embodiment, the third roller 130 has the same shape and diameter as the fourth roller 140, but the present disclosure is not limited thereto. In some embodiments, the third roller and the fourth roller may be different in diameter.

The feeding guiding structure 160 is positioned close to a side of the first roller 110 and the second roller 120 which are opposite to the middle guiding structure 150. From the point of view of FIG. 2, the feeding guiding structure 160 is positioned above the first roller 110 and the second roller 120. At least a part of the feeding guiding structure 160 is positioned in the first feeding section G1a of the first zone G1. In detail, the feeding guiding structure 160 has a cone shaped end 160a positioned in the first feeding section G1a, and the feeding guiding structure 160 has a feeding passage 160s. The cone shaped end 160a is favorable for the feeding passage 160s to be placed closer to the third roller 130 and the fourth roller 140; also, the cone shaped end 160a is favorable for the feeding passage 160s to be aligned with the first pressing section G1b of the first zone G1, to guide the filament 9 to feed into the first zone G1.

The extruding guiding structure 170 is positioned close to a side of the third roller 130 and the fourth roller 140 which are opposite to the middle guiding structure 150. From the point of view of FIG. 2, the extruding guiding structure 170 is positioned below the third roller 130 and the fourth roller 140. At least a part of the extruding guiding structure 170 is positioned in the second extruding section G2c of the second zone G2. In detail, the extruding guiding structure 170 has a cone shaped end 170b positioned in the second extruding section G2c, and the extruding guiding structure 170 has a feeding passage 170s. The cone shaped end 170b is favorable for the feeding passage 170s to be placed closer to the third roller 130 and the fourth roller 140; also, the cone shaped end 170b is favorable for the feeding passage 170s to be aligned with the second pressing section G2b of the second zone G2, to guide the filament 9 to feed into the second zone G2.

Then, please refer back to FIGS. 1 to 4, the first belt 180 penetrates through the first zone G1, the feeding passage 150s and the second zone G2, and the first belt 180 is surroundingly installed on the first roller 110 and the third roller 130. Thus, the first roller 110 and the third roller 130 are able to be moved simultaneously by the first belt 180. That is, by the first belt 180, the third roller 130 is able to be simultaneously rotated in the direction of arrow C as well.

The second belt 190 penetrates through the first zone G1, the feeding passage 150s and the second zone G2, and the second belt 190 is surroundingly installed on the second roller 120 and the fourth roller 140. Thus, the first roller 110 and the fourth roller 140 are able to be moved simultaneously by the second belt 190. That is, by the second belt 190, the fourth roller 140 is able to be simultaneously rotated in the direction of arrow D as well. In addition, the first belt 180 and the second belt 190 are for pressing and feeding the filament 9 while the filament 9 is passed through the first zone G1, the feeding passage 150s and the second zone G2.

In addition, the first belt 180 and the second belt 190 are made of, for example, rubber. Furthermore, in this embodiment, the first belt 180 and the second belt 190 are belts each having a smooth inner surface and a smooth outer surface, but the present disclosure is not limited thereto. In some embodiments, the first belt and the second belt may be toothed belts (also called timing belt, cogged belt or cog belt), in such a case, the first roller, the second roller, the third roller and the fourth roller are toothed rollers, and the teeth of the toothed belts and the teeth of the toothed rollers match up with each other.

The first tension wheel 181 removably pressing an outer surface of the first belt 180 that is not attached on the first roller 110 and the third roller 130. Thus, the tension of the first belt 180 is adjustable by adjusting the pressure, provided by the first tension wheel 181, on the first belt 180.

The second tension wheel 191 removably pressing an outer surface of the second belt 190 that is not attached on the second roller 120 and the fourth roller 140. Thus, the tension of the second belt 190 is adjustable by adjusting the pressure, provided by the second tension wheel 191, on the second belt 190.

Therefore, by the adjustment of the first tension wheel 181 or the second tension wheel 191, a distance d between the first belt 180 and the second belt 190 in the first zone G1, the feeding passage 150s and the second zone G2 is able to be adjusted in order to adjust the pressure on the filament 9. That is, the first tension wheel 181 and the second tension wheel 191 are able to adjust the pressure on the filament 9 by pressing the first belt 180 and the second belt 190, or release its pressure on the first belt 180 and the second belt 190.

In this and some embodiments, the third roller 130, the fourth roller 140, the feeding guiding structure 160, the extruding guiding structure 170, the first belt 180, the first tension wheel 181, the second belt 190 and the second tension wheel 191 are optional, and the number of each of them is not restricted, but the present disclosure is not limited thereto.

For example, in another embodiment, the feeding device may only have a configuration of the first roller, the second roller and the middle guiding structure; in yet another embodiment, the feeding device may only have a configuration of the first to fourth rollers and the middle guiding structure; in yet still another embodiment, the feeding device may only have a configuration of the first roller, the second roller, the feeding guiding structure and the middle guiding structure; in yet still another embodiment, the feeding device may only have a configuration of the first to fourth rollers, the middle guiding structure and the extruding guiding structure; in yet still another embodiment, the first belt and the second belt may be omitted in the feeding device; in yet still another embodiment, either the first tension wheel or the second tension wheel may be omitted in the feeding device.

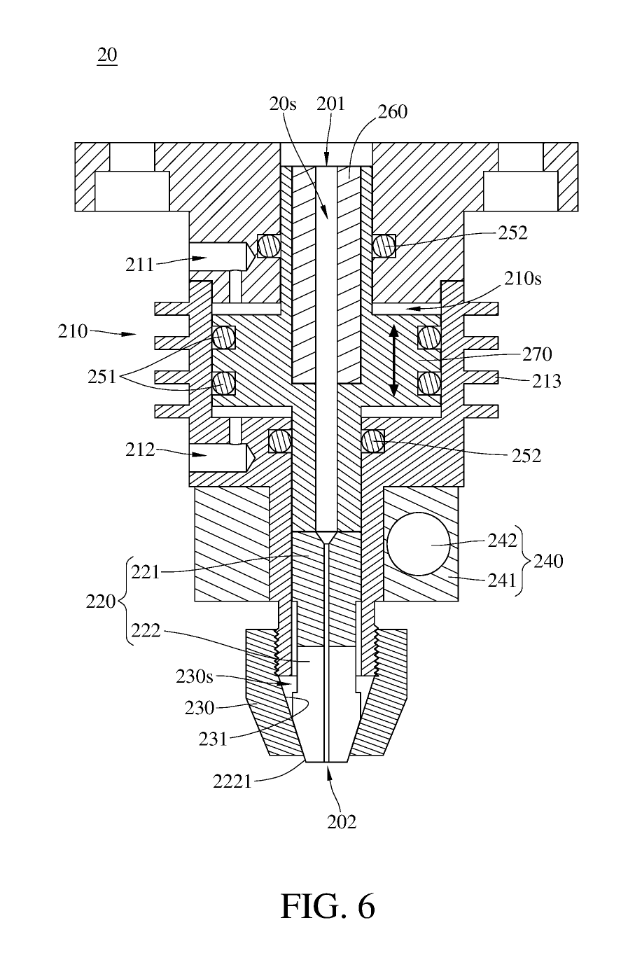

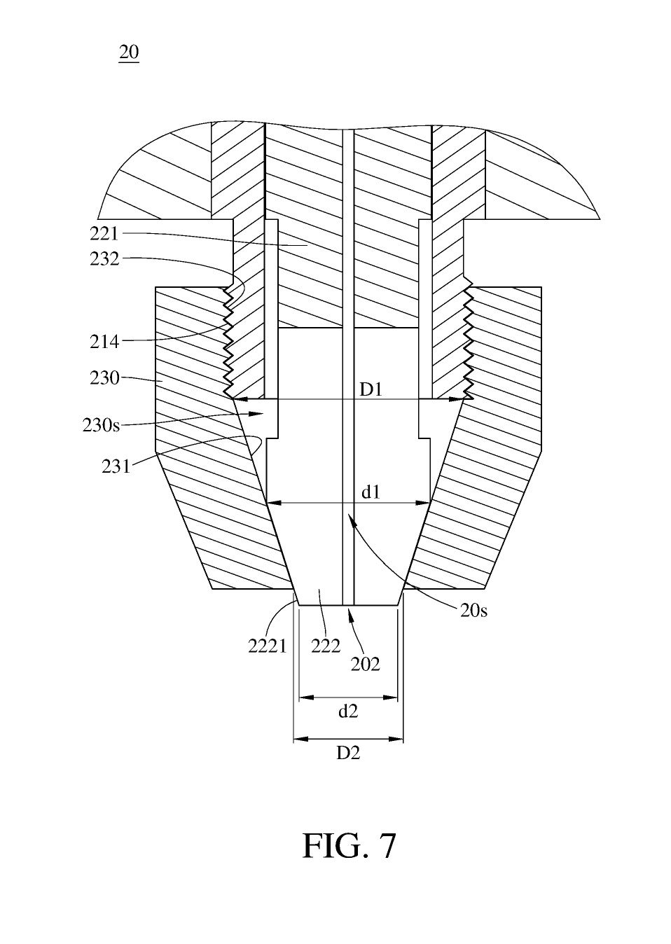

Then, please refer to FIG. 2, FIG. 5, and further refer to FIGS. 6 and 7. FIG. 6 is a side cross-sectional view of a variable squeezing mouth in FIG. 1, and FIG. 7 is a partial enlarged view of the variable squeezing mouth in FIG. 6. The variable squeezing mouth 20 is disposed on a side of the case 7 and positioned at a side of the extruding guiding structure 170 opposite to the first roller 110 and the second roller 120. In addition, the variable squeezing mouth 20 has an extruding passage 20s penetrating through the variable squeezing mouth 20. Two opposite ends of the extruding passage 20s respectively have a filament inlet 201 and a filament outlet 202. The filament inlet 201 is connected to the feeding passage 170s in order to receive the filament 9 from the feeding passage 170s.

In detail, the variable squeezing mouth 20 includes a main body 210, a collet 220, a nut 230, a hot end 240, two O-rings 251, two O-rings 252, a cylindrical wrap 260 and a piston 270. The extruding passage 20s penetrates through the collet 220, the cylindrical wrap 260 and the piston 270.

The main body 210 is connected to the feeding device 10 and mounted on a side of the case 7. The main body 210 has a chamber 210s, a first gas hole 211, a second gas hole 212, a heat sink 213 and multiple external threads 214. The first gas hole 211 and the second gas hole 212 are respectively positioned at two opposite sides of the chamber 210s, and the first gas hole 211 and the second gas hole 212 are connected to the chamber 210s. The heat sink 213 is positioned on an outer surface of the main body 210 corresponding to the chamber 210s, and the chamber 210 is surrounded by the heat sink 213. The external threads 214 are positioned on an end of the main body 210 close to the filament outlet 202.

The piston 270 is movable inside the chamber 210s. A part of the cylindrical wrap 260 is positioned inside the piston 270, and the cylindrical wrap 260 surrounds a part of the extruding passage 20s. The cylindrical wrap 260 is made of, for example, a material having good resistance of high temperature. The first gas hole 211 and the second gas hole 212 are respectively positioned at two opposite sides of the piston 270. In this embodiment, the chamber 210s is, for example, an air cylinder, the chamber 210s is able to be connected to a pneumatic machine, so that it is optional to inject compressed gases into the first gas hole 211 or the second gas hole 212 to adjust the air pressure in the chamber 210s in order to move the piston 270 toward the first gas hole 211 or the second gas hole 212 along the extruding passage 20s.

The collet 220 includes a base 221 and four arms 222. The base 221 is connected to a side of the piston 270, and the four arms 222 are separated from one another. The four arms 222 are positioned on a side of the base 221 and protrude from an end of the main body 210 having the external threads 214. The base 221 and the four arms 222 are movable with respect to the main body 210 by the movement of the piston 270.

In this embodiment, the piston 270 and the collet 220 are formed into a single body, but the present disclosure is not limited thereto. In some embodiments, the piston and the collet may be two independent structures.

The filament outlet 202 is formed by the four arms 222. The size of the filament outlet 202 is changed while a force is applied on the arms 222 to force the arms 222 to deform and move with respect to the base 221. When said force applied on the arms 222 is canceled, the arms 222 respectively return to their original positions by their elastic recovery forces. However, the present disclosure is not limited to the number of the arms 222. In some embodiments, the number of the arms may be two or over four.

In more detail, in this embodiment, each arm 222 further has an outer curved surface 2221. A side of the outer curved surfaces 2221 close to the base 221 has a first distance d1, another side of the outer curved surfaces 2221 away from the base 221 has a second distance d2, and the first distance d1 is larger than the second distance d2. Thus, the outer curved surfaces 2221 form a cone shape which it has a larger diameter closer to the base 221 than its smaller diameter.

The nut 230 has internal threads 232 matching the external threads 214 of the main body 210, and the nut 230 wraps around the arms 222, so that the nut 230 is movably engaged in the main body 210 and is movable with respect to the arms 222. In addition, in this embodiment, the nut 230 further has a cone-shaped space 230s and an inner surface 231 forming the cone-shaped space 230s. The cone-shaped space 230s is more away from the base 221 than the internal threads 232. A side of the cone-shaped space 230s close to the base 221 has a first diameter D1, another side of the cone-shaped space 230s away from the feeding device has a second diameter D2 (i.e. a diameter of an opening of the nut), and the first diameter D1 is greater than the second diameter D2. That is, the cone-shaped space 230s having a larger opening closer to the base 221 than its smaller opening. The second diameter D2 is between the first distance d1 and the second distance d2. Therefore, the inner surface 231 of the nut 230 is tightly in contact with or pressed against the outer curved surfaces 2221 of the arms 222.

However, the present disclosure is not limited to the design of the outer curved surface 2221s of the arm 222 and the cone-shaped space 230s of the nut 230. In another embodiment, each of the outer surfaces of the arms may be not a curved surface. In such a case, the nut 230 still has the cone-shaped space 230s. In yet another embodiment, the shape of the space in the nut may be not in a cone shape. In such a case, the arm 222 still has the outer curved surface 2221.

The hot end 240 is disposed on the main body 210 and positioned close to the collet 220. The hot end 240 is for heating up the filament 9 in the extruding passage 20s. The hot end 240 includes a heat source 241 and a heating block 242. The heat source 241 is configured to heat up the heating block 242. In a measurement result, the heating block 242 is able to be heated up to 180 to 240 Celsius degrees, but the present disclosure is not limited thereto. The heating block 242 is made of, for example, aluminum, but the present disclosure is not limited thereto.

The O-rings 251 and the O-rings 252 are positioned between the hot end 240 and the filament inlet 201, and the O-rings 251 and 252 are configured to airtight seal and thermal insulation. In detail, the O-rings 251 are embedded onto the piston 270. The O-rings 252 are embedded into the main body 210 and respectively positioned at two opposite sides of the piston 270. However, the present disclosure is not limited to the number of these O-rings. In some embodiments, the variable squeezing mouth may have only one O-ring.

Then, the operation of the feeding device and the variable squeezing mouth are described in the following paragraphs.

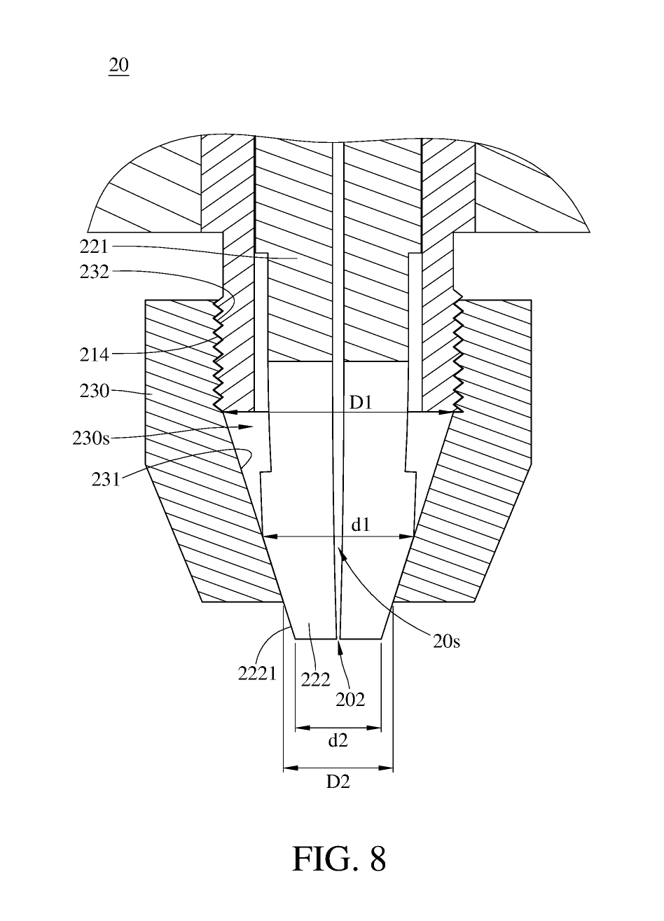

Please refer back to FIG. 2, FIGS. 5 to 7 and further refer to FIG. 8, FIG. 8 shows the operation of the variable squeezing mouth in FIG. 6. Firstly, the filament 9 is inserted into the feeding passage 160s of the feeding guiding structure 160. Since a part of the feeding guiding structure 160 is positioned in the first feeding section G1a of the first zone G1, and the feeding passage 160s is aligned with and connected to the first pressing section G1b of the first zone G1, the feeding passage 160s is positioned close to the first roller 110 and the second roller 120, so that the filament 9 is not easy to become deformed, tangled or go off-track while the filament 9 is fed from the feeding passage 160s to the first zone G1. Then, when the filament 9 is inserted or fed into the first zone G1, the filament 9 is pressed by the first belt 180 and the second belt 190, and the filament 9 is moved toward the middle guiding structure 150 by being driven by the first belt 180 and the second belt 190. Since a part of the middle guiding structure 150 is positioned in the first extruding section G1c of the first zone G1, and the feeding passage 150s is aligned with and connected to the first pressing section G1b of the first zone G1, the feeding passage 150s is positioned close to the first roller 110 and the second roller 120, so that the filament 9 is not easy to become deformed, tangled or go off-track while the filament 9 is being fed from the first zone G1 through the zone between the first belt 180 and the second belt 190 that are positioned in the feeding passage 150s. Then, since a part of the middle guiding structure 150 is positioned in the second feeding section G2a of the second zone G2, and the feeding passage 150s is aligned with and connected to the second pressing section G2b of the second zone G2, the feeding passage 150s is positioned close to the third roller 130 and the fourth roller 140, so that the filament 9 is not easy to become deformed, tangled or go off-track while the filament 9 is inserted or fed into the second zone G2 from the feeding passage 150s by the guide of the first belt 180 and the second belt 190 that are positioned in the feeding passage 150s. Then, since a part of the extruding guiding structure 170 is positioned in the second extruding section G2c of the second zone G2, and the feeding passage 170s is aligned with and connected to the second pressing section G2b of the second zone G2, the feeding passage 170s is positioned close to the third roller 130 and the fourth roller 140, so that the filament 9 is not easy to become deformed, tangled or go off-track while the filament 9 is inserted or fed into the feeding passage 170s of the extruding guiding structure 170 from the second zone G2.

That is, the distances among the feeding guiding structure 160, the middle guiding structure 150, the extruding guiding structure 170 and all of the rollers are close enough, so that the filament 9 is guided and supported while being fed, and is able to be fed in a predetermined route to be extruded into the variable squeezing mouth 20. In addition, while feeding the filament 9, the first belt 180 and the second belt 190 support and guide the filament 9 in order to prevent the filament 9 from becoming deformed, tangled or going off-track. Therefore, the feeding device 10 is able to feed very soft filament without causing the filament to become deformed, tangled or go off-track while feeding the filament.

In addition, the tension of the first belt 180 and the tension of the second belt 190 are able to be adjusted by respectively adjusting the first tension wheel 181 and the second tension wheel 191, thereby letting the first belt 180 and the second belt 190 to properly guide and press the filament 9. Thus, the pressure on the filament 9 is proper, so that the filament 9 is prevented from being overly pressed while being fed.

Then, the filament 9 is fed into the filament inlet 201 of the extruding passage 20s from the feeding passage 170s. When the filament 9 passes through the hot end 240, the filament 9 is heated and melted to a molten state by the hot end 240. The filament 9 in the molten state is extruded from the filament outlet 202, and is deposited on a platform layer by layer to gradually build up a 3D object. During the building process, the cylindrical wrap 260 is able to protect the filament 9 inside the piston 270 from being heated before the filament 9 arrives to the hot end 240, so the filament 9 is prevented from melting ahead of schedule.

It is noted that, according to actual requirements, the size of the filament outlet 202 is able to be changed by adjusting the collet 220 and/or the nut 230 while the melted filament 9 is extruded from the filament outlet 202, and thereby adjusting the amount of the extruded filament 9. For example, as shown in FIGS. 6 to 8, it is optional to inject compressed air into the first gas hole 211 to force the collet 220 to protrude outward or inward with respect to the main body 210. In such a case, the outer curved surfaces 2221 of the arms 222 are pressed by the inner surface 231 of the nut 230, so that the arms 222 are deformed and their ends are moved closer to one and another, thereby decreasing the size of the filament outlet 202. In another embodiment, the size of the filament outlet 202 is also changed by rotating the nut 230. In such a case, the outer curved surfaces 2221 of the four arms 222 can be pressed by the inner surface 231 of the nut 230 so that the arms 222 are deformed and their ends are moved closer to one and another. Apparently, the size of the filament outlet 202 can be changed by adjusting either the collet 220, or the nut 230, or both of them, but the present disclosure is not limited thereto.

According to a measurement result, the adjustment range of the size of the filament outlet 202 ranges about between 0.1 millimeters and 0.4 millimeters. The radial size of the melted filament is substantially the size of the filament outlet 202. Also, since the position of the arm 222, with respect to the nut 230, is able to be adjusted by adjusting the air pressure, the size of the filament outlet 202, defined by the arms 222, is able to be adjusted without any steps (also called stepless adjustment) in order to finely adjust the radial size of the melted filament according to different qualities required by different portions of one product. Accordingly, the time spent on printing the product is shortened, the quality of the end product is improved, and it is favorable for printing customized products with complicated structures.

According to the feeding device as discussed above, a part of the middle guiding structure is positioned in the first zone which is between the first roller and the second roller, and the middle passage of the middle guiding structure is aligned with and connected to the first zone, so the filament pressed and fed by the two rollers is directly fed or inserted into the middle guiding structure, and the filament inside the middle guiding structure is supported by the middle guiding structure. Therefore, the filament is prevented from being deformed, tangled or going off-track while being fed.

In addition, according to the variable squeezing mouth as discussed above, the collet is movable with respect to the main body via the base, and the nut is also movable with respect to the main body, so the size of the filament outlet of the collet is able to be changed by moving the nut and/or the collet, and the size of the filament outlet is able to be adjusted without any steps. Thus, the radial size of the melted filament is able to be finely adjusted according to different qualities required by different portions of one product, so that the time spent on printing the product is shortened, the quality of the end product is improved, and it is favorable for printing customized products with complicated structures.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A feeding device for 3D printing, the feeding device for feeding a filament, comprising:
a first roller;
a second roller being positioned close to the first roller and being movable by the first roller, the second roller and the first roller having a first zone therebetween, and the second roller and the first roller for pressing and feeding the filament; and
a middle guiding structure, at least a part of the middle guiding structure being positioned in the first zone, and the middle guiding structure having a passage being aligned with and connected to the first zone.

2. The feeding device according to claim 1, further comprising a third roller and a fourth roller which are positioned close to each other, the third roller and the fourth roller positioned below the middle guiding structure, the third roller and the fourth roller having a second zone therebetween, at least a part of the middle guiding structure being positioned in the second zone, and another end of the passage of the middle guiding structure being aligned with and connected to the second zone.

3. The feeding device according to claim 2, further comprising a feeding guiding structure positioned above the first roller and the second roller, at lease a part of the feeding guiding structure being positioned in the first zone, and the feeding guiding structure having a passage being aligned with and connected to the first zone.

4. The feeding device according to claim 3, further comprising an extruding guiding structure being positioned below the third roller and the fourth roller, at least a part of the extruding guiding structure being positioned in the second zone, and the extruding guiding structure having a passage being aligned with and connected to the second zone.

5. The feeding device according to claim 2, further comprising a first belt and a second belt, the first belt penetrating through the feeding passage of the middle guiding structure, the first belt being surroundingly installed on the first roller and the third roller, the second belt penetrating through the feeding passage of the middle guiding structure, the second belt being surroundingly installed on the second roller and the fourth roller, the first belt and the second belt for pressing the filament and feeding the filament into the first zone.

6. The feeding device according to claim 5, wherein the first roller and the third roller are movable simultaneously by the first belt.

7. The feeding device according to claim 5, wherein the fourth roller and the second roller are movable simultaneously by the second belt.

8. The feeding device according to claim 5, wherein when the filament is positioned between the first belt and the second belt that are positioned between the first roller and the second roller, the filament fed through the middle guiding structure by the guide of the first belt and the second belt.

9. The feeding device according to claim 5, wherein the first belt and the second belt are toothed belts, and the first roller, the second roller, the third roller and the fourth roller are toothed rollers, and the teeth of the toothed belts and the teeth of the toothed rollers match up with each other.

10. The feeding device according to claim 5, further comprising a first tension wheel removably pressing the first belt in order to adjust the tension of the first belt.

11. The feeding device according to claim 5, further comprising a second tension wheel removably pressing the second belt in order to adjust the tension of the second belt.

12. The feeding device according to claim 1, further comprising a drive roller set, the drive roller set comprising a first engaged roller and a second engaged roller which are engaged with each other, the first engaged roller being fixed to the first roller in order to drive the first roller, the first roller being connected to a power source through the first engaged roller, and the second engaged roller being fixed to the second roller in order to drive the second roller.

13. A variable squeezing mouth for 3D printing, the variable squeezing mouth having an extruding passage for extruding a filament, the variable squeezing mouth comprising:
a main body;
a collet, comprising a base and at least two arms, the base being movably disposed on the main body, the at least two arms being separated from one another and positioned on a side of the base, the extruding passage penetrating the main body and the collet, and the at least two arms forming a filament outlet of the extruding passage; and
a nut being movably engaged in the main body and wrapping around the at least two arms, wherein while the nut or the collet is moved with respect to the main body, the at least two arms and the nut are pressed against each other, so that a distance between the at least two arms is changed, and the size of the filament outlet is changed.

14. The variable squeezing mouth according to claim 13, wherein each of the at least two arms has an outer curved surface, a first distance between the two outer curved surfaces at a side of the at least two arms close to the base is greater than a second distance between the two outer curved surfaces at a side of the at least two arms away from the base, the nut has an opening, and a diameter of the opening is between the first distance and the second distance.

15. The variable squeezing mouth according to claim 13, wherein the nut has a cone-shaped space and an inner surface forming the cone-shaped space, a side of the cone-shaped space close to the base has a first diameter, another side of the cone-shaped space away from the base has a second diameter, and the first diameter is greater than the second diameter.

16. The variable squeezing mouth according to claim 13, wherein each of the at least two arms has an outer curved surface, a first distance between the two outer curved surfaces at a side of the at least two arms close to the base is greater than a second distance between the two outer curved surfaces at a side of the at least two arms away from the base, the nut has a cone-shaped space and an inner surface forming the cone-shaped space, a side of the cone-shaped space close to the base has a first diameter, another side of the cone-shaped space away from the base has a second diameter, the first diameter is larger than the second diameter, and the second diameter is between the first distance and the second distance.

17. The variable squeezing mouth according to claim 13, further comprising a piston, the base of the collet being connected to a side of the piston, wherein the main body has a chamber, a first gas hole and a second gas hole which are connected to one another, the piston is movable inside the chamber, the first gas hole and the second gas hole are respectively positioned at two opposite sides of the piston, the first gas hole or the second gas hole is configured to be connected to a pneumatic machine in order to adjust the air pressure of the chamber to move the piston.

18. The variable squeezing mouth according to claim 17, further comprising a cylindrical wrap, a part of the cylindrical wrap being positioned inside the piston, and the cylindrical wrap surrounding a part of the extruding passage.

19. The variable squeezing mouth according to claim 13, further comprising a hot end disposed on the main body, the hot end positioned close to the collet, and the hot end configured to heat the filament in the extruding passage.

20. The variable squeezing mouth according to claim 19, further comprising at least one O-ring embedded in the main body, the at least one O-ring positioned between the hot end and a filament inlet of the extruding passage.
